(19) United States
(12) Patent Application Publication
(10) Pub. No.: US 2014/0314580 A1
(43) Pub. Date: Oct. 23, 2014

(54) WIND TURBINE

(71) Applicant: SIEMENS AKTIENGESELLSCHAFT, MÜNCHEN (DE)

(72) Inventors: Soeren Oemann Lind, Naestved (DK); Henrik Stiesdal, Odense C (DK)

(21) Appl. No.: 14/354,990

(22) PCT Filed: Nov. 16, 2012
(86) PCT No.: PCT/EP2012/072880

§ 371 Date: Apr. 29, 2014

(30) Foreign Application Priority Data
Dec. 6, 2011 (EP) 11192187.0

(51) Int. Cl. F03D 11/04

(52) U.S. Cl. CPC F03D 11/04
USPC 416/244 R

(57) ABSTRACT

A wind turbine including a load carrying component made of or at least comprising a fibre-reinforced composite material is provided. The wind turbine also includes a stator endplate or rotor endplate of a direct drive generator where in the stator endplate or rotor endplate is made of or includes a fibre reinforced composite material.

### CROSS REFERENCE TO RELATED APPLICATIONS

This application is the U.S. National Stage of International Application No. PCT/EP2012/072880 filed Nov. 16, 2012 and claims benefit thereof, the entire content of which is hereby incorporated herein by reference. The International Application claims priority to the European Patent Office application No. 11192187.0 EP filed Dec. 6, 2011, the entire contents of which is hereby incorporated herein by reference.

### FIELD OF THE INVENTION

The invention relates to a wind turbine.

### BACKGROUND ART

Since the beginning of building wind turbines, it has been known to build wind turbine components and structures such as towers, bed plates, main shafts, nacelle enclosures, hubs etc. in casted or rolled iron or steel. This has been done as iron and steel are very cheap materials, are easy to process and have suitable mechanical properties to be able to e.g. withstand loads acting on the said structures and components.

EP 2143941 B1 discloses a wind turbine with a stator endplate of a DD generator.

EP 2143941 B1 discloses a wind turbine with a shaft connecting hub to generator of a DD generator.

U.S. 2011148113 discloses a wind turbine with a shaft connecting hub to generator of a geared wind turbine.

WO 2011/076796 discloses a wind turbine with a hub of a wind turbine.

WO2003064854 A discloses a wind turbine with a hub reinforcement plate or a blade root reinforcement plate at the pitch bearings of a wind turbine rotor blade.

As the wind turbines become larger, the structure and components become heavier and consequently the installation of the turbines have become much more expensive as larger and larger cranes are needed to lift and install the very heavy components.

### DESCRIPTION OF THE INVENTION

It is therefore an object by the present invention to provide wind turbine components which are optimized in relation to weight versus strength.

This objective is solved by the claims. The depending claims define further developments of the invention.

The inventive wind turbine comprises a load carrying component. The load carrying component comprises fibre reinforced composite material. For example, the load carrying component may consist of or may be made of fibre reinforced composite material.

A load carrying component is a component supporting or carrying at least one other component. A wind turbine rotor blade is not a load carrying component in the sense of the present invention.

The present invention relates in general to manufacture wind turbine components/structures belonging to the group of:
stator or rotor endplates (DD generator)
stator hollow tube construction (DD generator)
rotor sleeve (DD generator)
shaft connecting hub to generator (DD generator)
shaft connecting hub to gearbox (geared turbine)
shaft connecting hub to hydraulic aggregate (hydraulic geared turbine)
hub (DD generator, geared and hydraulic geared turbine)
reinforcement plate ad blade root (DD generator, geared and hydraulic geared turbine)
yaw-frame (DD generator, geared and hydraulic geared turbine)
tower flange
supporting beam
canopy supporting structure.

All of the mentioned components/structures are examples for load carrying components according to the present invention. By casting these components in e.g. one of the aligned fibre-reinforced composite configurations, it is possible to direct the reinforcement fibers in the directions of loads acting on the specific component. Consequently it is possible to exploit the strong load resistant properties of the fibers and of the composite materials maximally and in turn it is ensured that a very strong load carrying structure can be build, even with a minimum of materials.

As many of these composite materials are relatively easy and in-expensive to manufacture, the invention in turn this makes the structures/components cost effective. Furthermore, as most of these fibre-reinforced composite materials are of lighter weight density compared to steel or iron, it is ensured that components/structures can be build which can withstand the same loads as conventional steel or iron components, but which are much lighter.

Even further, as a nacelle comprising the invented structures/components become lighter than similar nacelles known in the art, installation costs may be reduced as e.g. cranes provided for lifting the nacelle does not need to have the same lifting capabilities.

More specific, the mentioned components are according to the invention manufactured/casted fibre-reinforced composite materials. In other words, the components comprise fibre-reinforced composite material or are made of or consist of fibre-reinforced composite material. Generally speaking the said composite materials are made of two or more constituent materials such as a reinforcement fiber and a resin matrix.

The fibre-reinforced composite materials can be configured in 3 ways i.e.

continuous, discontinuous or discontinuous, random-oriented fibre-reinforced composite. By the term continuous aligned fibre is meant that the individual fibers are arranged in such a manner that they lay relative close and that adjacent fibers to a large extent overlap in lengthwise direction in the composite. In contrast hereto discontinuous aligned fibres are arranged so that they do now in a large extend do overlap.

In a first variant or aspect of the invention the inventive wind turbine comprises a direct drive generator, a stator endplate and/or a rotor endplate of the direct drive generator. The stator endplate or rotor endplate is made of or at least comprises fibre reinforced composite material.

In a second variant or aspect of the invention the inventive wind turbine comprises a direct drive generator and a stator hollow tube construction of the direct drive generator. The stator hollow tube construction is made of or at least comprises fibre reinforced composite material.

In a third variant or aspect of the invention the inventive wind turbine comprises a direct drive generator and a rotor sleeve of the direct drive generator. The rotor sleeve is made of or at least comprises fibre reinforced composite material.

In a fourth variant or aspect of the invention the inventive wind turbine comprises a direct drive generator, a hub and a shaft of the direct drive generator connecting the hub to the generator. The shaft is made of or at least comprises fibre reinforced composite material.

In a fifth variant or aspect of the invention the inventive wind turbine comprises a gearbox, a hub and a shaft connecting the hub to the gearbox of the geared turbine. The shaft is made of or at least comprises fibre reinforced composite material.

In a sixth variant or aspect of the invention the inventive wind turbine comprises a hydraulic geared turbine with a hydraulic aggregate, a hub and a shaft connecting the hub to the hydraulic aggregate of the hydraulic geared turbine. The shaft is made of or at least comprises fibre reinforced composite material.

In a seventh variant or aspect of the invention the inventive wind turbine comprises a direct drive generator, a hub of the direct drive generator and a geared or a hydraulic geared turbine. The hub is made of or at least comprises fibre reinforced composite material.

In an eighth variant or aspect of the invention the inventive wind turbine comprises a direct drive generator, a geared or a hydraulic geared turbine. It further comprises at least one blade with a blade root and a reinforcement plate at the blade root of the direct drive generator, the geared or the hydraulic geared turbine. The reinforcement plate is made of or at least comprises fibre reinforced composite material.

In a ninth variant or aspect of the invention the inventive wind turbine comprises a direct drive generator, a geared or a hydraulically geared turbine. It further comprises a yaw-frame of the direct drive generator, the geared or the hydraulically geared turbine. The yaw-frame is made of or at least comprises fibre reinforced composite material.

In a tenth variant or aspect of the invention the inventive wind turbine comprises a tower flange. The tower flange is made of or at least comprises fibre reinforced composite material.

In an eleventh variant or aspect of the invention the inventive wind turbine comprises a supporting beam. The supporting beam is made of or at least comprises fibre reinforced composite material. For instance, for a direct drive wind turbine construction electric cabinets etc. may be located in the downwind end of the nacelle. This may require one or more beams which are connected to the bedplate at some joint. The requirements to the said beams are high as a high bending moment is applied to the construction. Furthermore the construction may cope with the dynamical motion of the wind turbine. Such supporting beams are relatively easy to manufacture as the said bending moments are relatively unidirectional and consequently the orientation of fibres in the structure is non-complex.

In a twelfth variant or aspect of the invention the inventive wind turbine comprises a canopy supporting structure. The canopy supporting structure is made of or at least comprises fibre reinforced composite material. Such construction is advantageous in that by making the structure in composite fibre material including carbon fibre material, the weight of the construction is reduced in comparison to prior art where similar constructions are made in metal such as steel or aluminium.

The use of fibre reinforced composite material reduces the weight of the mentioned components and improves the components in relation to weight versus strength.

In all mentioned components the fibers of at least a part of the reinforced material can be configured as continuous aligned fibre reinforced material and/or the fibers of at least a part of the reinforced material can be configured as discontinuous aligned fibre reinforced material and/or the fibers of at least a part of the reinforced material can be configured as discontinuous random oriented fibre reinforced material.

Moreover, the reinforcement fibers are embedded in the composite material. The reinforcement may comprise reinforcement bars, such as made of steel, plastics, carbon, glass-fibre etc.

The material of the fibers can be or can comprise at least one of steel, carbon, glass, Kevlar, basalt or any combination thereof. The composite material can comprise a resin matrix. Furthermore, the matrix may be or may comprise at least one of concrete, epoxy, polyester, vinylester, iron, steel or any combination thereof. The concrete can be pre-stressed concrete.

### BRIEF DESCRIPTION OF THE DRAWINGS

Further features, properties and advantages of the present invention will become clear from the following description of embodiments in conjunction with the accompanying drawings. The embodiments do not limit the scope of the present invention which is determined by the appended claims. All described features are advantageous as separate features or in any combination with each other.

Corresponding elements of different figures are designated with the same reference numeral and are not repeatedly described.

FIG. 1 schematically shows a wind turbine.

FIG. 2 schematically shows fibre-reinforced composite material being configured in 3 ways.

FIG. 3 schematically shows endplates of a wind turbine in a sectional view.

FIG. 4 schematically shows a wind turbine with a stator hollow tube construction of a direct drive (DD) generator in a sectional view.

FIG. 5 schematically shows a rotor sleeve of a DD generator in a sectional view.

FIG. 6 schematically shows a sectional view of part of the rotor of one embodiment of a wind turbine.

FIG. 7 schematically shows a shaft connecting the hub to the generator of a DD generator.

FIG. 8 schematically shows a shaft connecting the hub to the generator of a geared wind turbine.

FIG. 9 schematically shows an embodiment of a hub of a wind turbine.

FIG. 10 schematically shows a hub reinforcement plate or a blade root reinforcement plate at the pitch bearings of a wind turbine rotor blade.

FIG. 11 schematically shows a yaw-frame as being a part of a bed plate of a wind turbine.

FIG. 12 schematically shows part of two tower segments connected with flanges in a sectional view.

FIG. 13 schematically shows part of two tower segments connected with flanges in a sectional view.

FIG. 14 schematically shows part of two tower segments connected with flanges in a sectional view.

FIG. 15 schematically shows an embodiment of a direct drive wind turbine in a sectional view.

FIG. 16 schematically shows part of a wind turbine with a supporting beam in a sectional view.

FIG. 17 schematically shows part of a wind turbine with a canopy supporting structure in a sectional view.

### DETAILED DESCRIPTION OF THE INVENTION

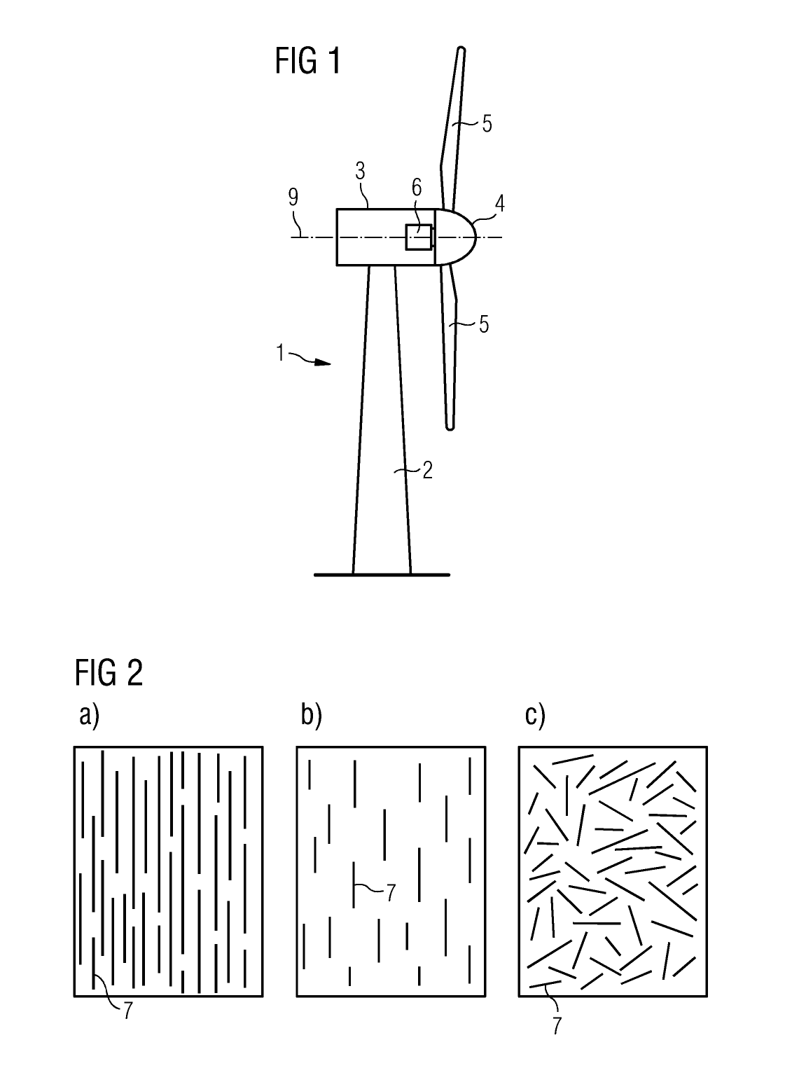

FIG. 1 schematically shows a wind turbine 1. The wind turbine 1 comprises a tower 2, a nacelle 3 and a hub 4. The nacelle 3 is located on top of the tower 2. The hub 4 comprises a number of wind turbine blades 5. The hub 4 is mounted to the nacelle 3. Moreover, the hub 4 is pivot-mounted such that it is able to rotate about a rotation axis 9. A generator 6 is located inside the nacelle 3. The wind turbine 1 is a direct drive wind turbine.

FIG. 2 schematically shows fibre-reinforced composite material being configured in 3 ways i.e.: continuous, aligned fibre-reinforced composite as shown in FIG. 2(a), discontinuous, aligned fibre-reinforced composite as shown in FIG. 2(b) or discontinuous, random-oriented fibre-reinforced composite as shown in FIG. 2(c). The fibres are designated by reference numeral 7.

As previously mentioned, by the term continuous aligned fibre is meant that the individual fibers 7 are arranged in such a manner that they lay relative close and that adjacent fibres 7 to a large extent overlap in lengthwise direction in the composite. In FIG. 2(a) the individual fibres are oriented parallel or nearly parallel to each other.

In contrast hereto discontinuous aligned fibres are arranged so that they do now in a large extend do overlap. This is schematically shown in FIG. 2(b), wherein the individual fibres 7 are oriented parallel or nearly parallel to each other.

FIG. 2(c) schematically shows random-oriented fibre-reinforced composite, wherein the individual fibres 7 are randomly oriented to each other. The individual fibres 7 include random angles with each other. Some of the individual fibres 7 do overlap.

Generally speaking the said composite materials are made of two or more constituent materials such as a reinforcement fibre and a resin matrix.

The fibres suitable for the present invention may e.g. be of the types steel, carbon, glass, kevlar or basalt. Other types of fibres suitable for making composite materials are however also included.

The resin matrix suitable for the present invention may e.g. be of the types concrete, epoxy, polyester, vinylester, iron, steel etc.

All of the components/structures which are mentioned above are load carrying components. By casting these components in e.g. one of the aligned fibre-reinforced composite configurations, it is possible to direct the reinforcement fibres in the directions of loads acting on the specific component. Consequently it is possible to exploit the strong load resistant properties of the fibres and of the composite materials maximally and in turn it is ensured that a very strong load carrying structure can be build, even with a minimum of materials.

As many of these composite materials are relatively easy and in-expensive to manufacture, the invention in turn this makes the structures/components cost effective. Furthermore, as most of these fibre-reinforced composite materials are of lighter weight density compared to steel or iron, it is ensured that components/structures can be build which can withstand the same loads as conventional steel or iron components, but which are much lighter.

Even further, as a nacelle comprising the invented structures/components become lighter than similar nacelles known in the art, installation costs may be reduced as e.g. cranes provided for lifting the nacelle does not need to have the same lifting capabilities.

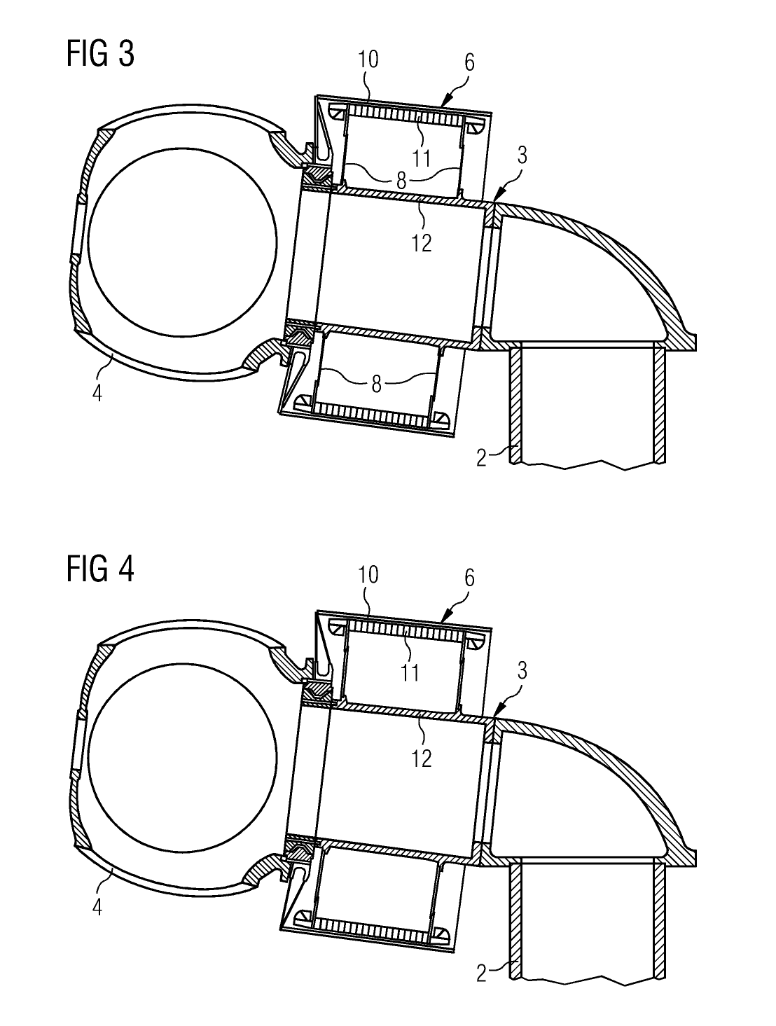

FIG. 3 schematically shows endplates 8 of a wind turbine in a sectional view.

The wind turbine comprises a rotor 10 and a stator 11. In the shown example, the wind turbine comprises a direct drive generator 6 with an outer rotor configuration. In this aspect of the invention, the stator endplates 8 are made of glass fibre material. However manufacturing the endplates 8 in e.g. carbon fibre composite material, i.e. fibres with even lower elasticity module than glass, makes the endplates 8—and in turn the whole stator construction—stronger and lighter than compared to a similar glass fibre construction. As the stator endplates 8 almost exclusively are influenced by torsion forces during operation, it is relatively simple to construct endplates 8 comprising aligned fibres in the direction of the acting forces.

FIG. 4 schematically shows a wind turbine with a stator hollow tube construction of a direct drive (DD) generator in a sectional view. In this aspect of the invention, the inventive component/structure is a stator hollow tube construction 12 of a DD generator 6. The stator hollow tube construction 12 is influenced by torsion forces in addition to horizontal as well as vertical bending moments. For this complex distribution of forces, random-oriented fibre reinforced composites or aligned fibre reinforced composites or a combination of the two can be used.

FIG. 5 schematically shows a rotor sleeve of a DD generator in a sectional view. In this aspect of the invention, the invented component/structure is a rotor sleeve 13 of a DD generator as schematically illustrated on the FIG. 5.

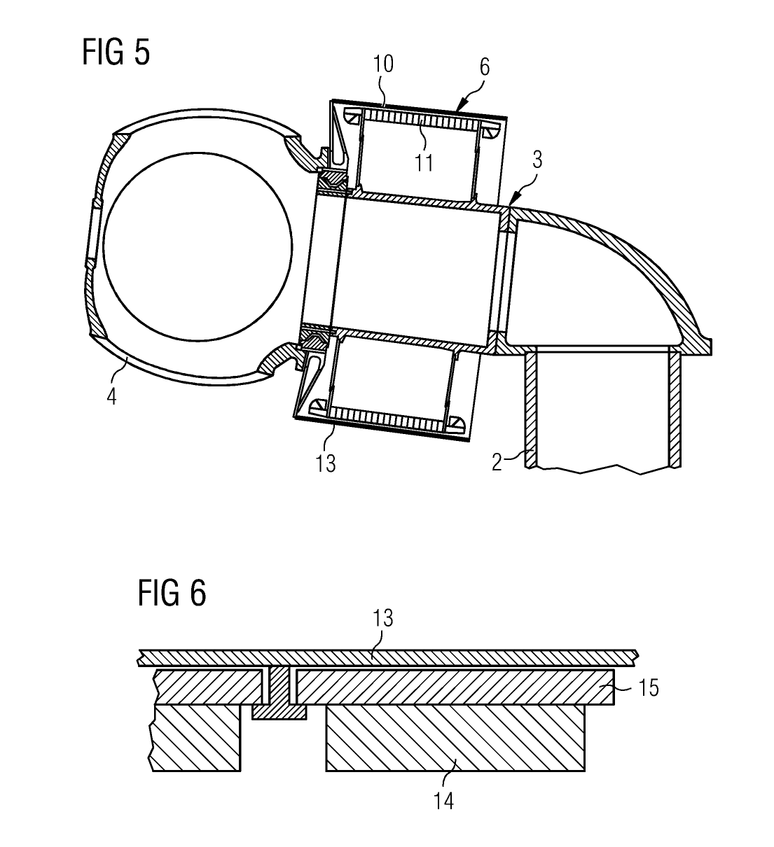

FIG. 6 schematically shows a sectional view of part of the rotor of one embodiment of a wind turbine. As can be seen, the magnets 14 are attached to some baseplate 15 which in turn is mounted and held in place in relation to the outer rotor sleeve 13. As it is known from prior art, the said rotor sleeve is made of rolled steel, so that the sleeve itself is magnetic conductive and can take part of the pathways of the magnetic flux-lines.

However, according to the present invention, the said rotor sleeve 13 can be made of the said composite materials. Hereby it is ensured that the rotor sleeve 13 can be made significantly thinner and lighter. It may for various embodiments of this aspect be necessary to increase the thickness of the magnet base plate 15 in order to maintain the pathways of the magnetic flux-lines.

In a further aspect of the invention, the invented component/structure is a rotating shaft of the wind turbine such as a shaft connecting hub to generator of a DD generator, a shaft connecting hub to gearbox of a geared wind turbine, or a shaft connecting hub to hydraulic aggregate of a hydraulic geared wind turbine.

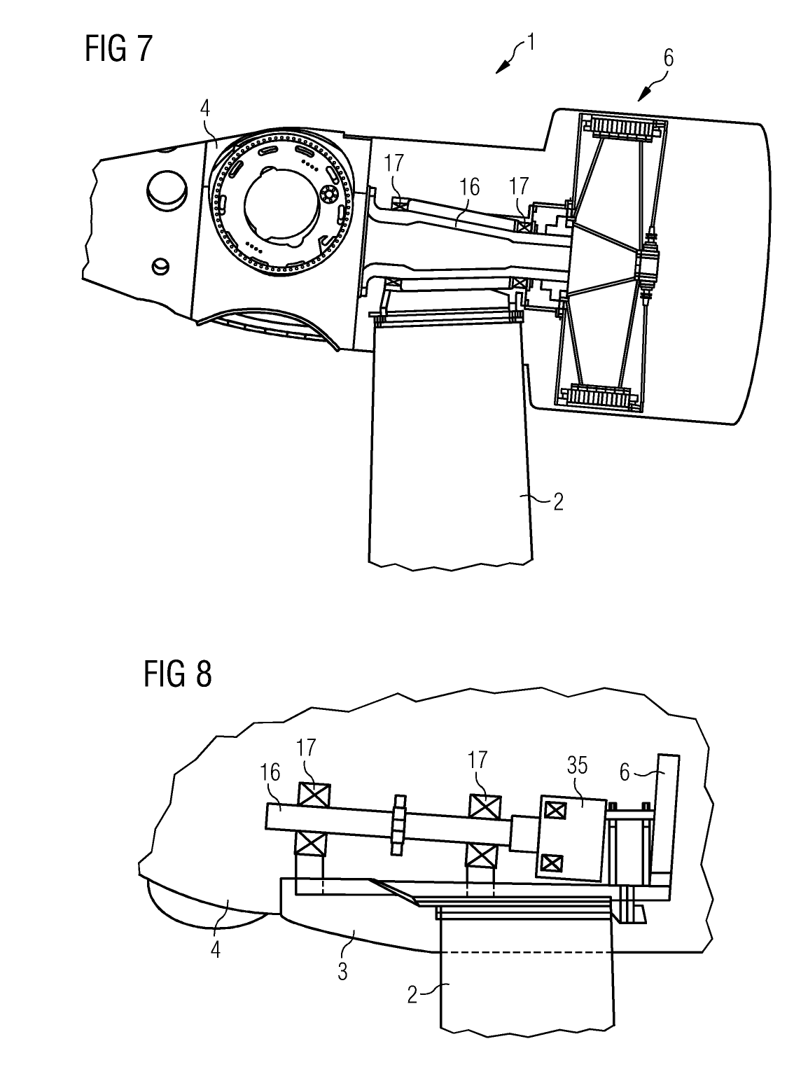

FIG. 7 schematically shows a shaft connecting the hub 4 to the generator 6 of a DD generator. The reference numeral 16 of FIG. 7 illustrates a low speed rotating main shaft. The shaft 16 may be solid or hollow and is held in place by main bearings 17.

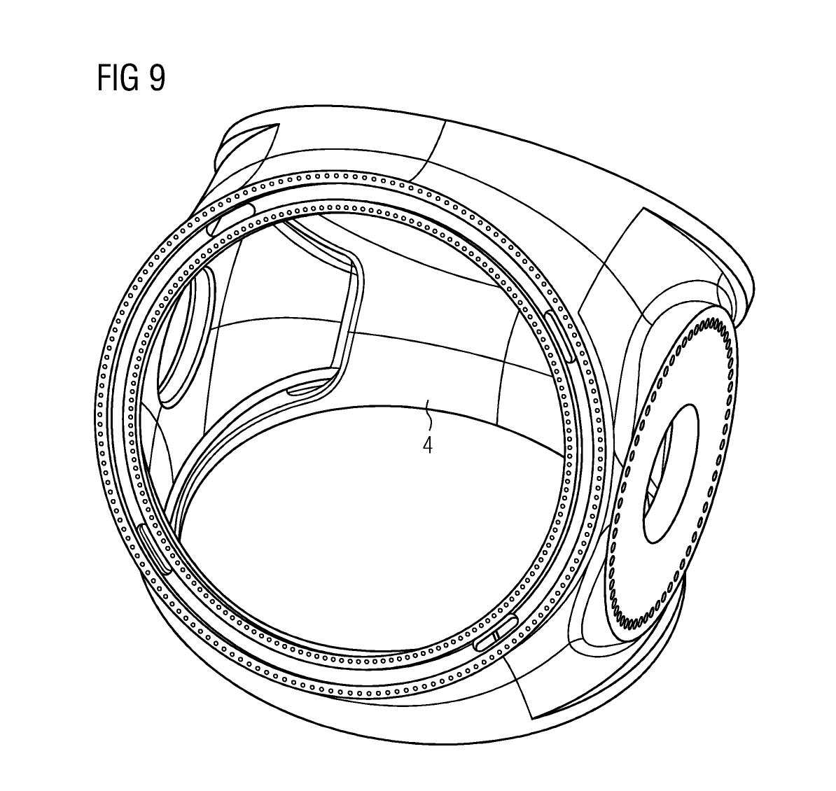

FIG. 8 schematically shows a shaft 16 connecting the hub 4 to the generator 6 of a geared wind turbine. The gearbox is indicated by reference numeral 35. The shaft may be a low speed rotating main shaft. The shaft 16 may be solid or hollow and is held in place by main bearings 17. In operation the shaft 16 experiences mainly torsion forces so it is relatively simple to construct shafts comprising aligned fibers in the direction of the acting forces, which in turn can take the torsion forces.

In a further aspect of the invention, the invented component/structure is a hub 4 of a wind turbine. FIG. 9 schematically shows a hub 4 of a wind turbine.

As wind turbines 1 become larger and larger, so do their hubs 4. For large scale wind turbines the hubs have now come to a size where it is very difficult for them to be iron-casted in one pieces as the casting facilities do not have the capacity for these components. However using the invented composite materials makes the casting of larger hubs feasible. For building such component in composite material, both aligned and random oriented fibre composites can be used—or a combination.

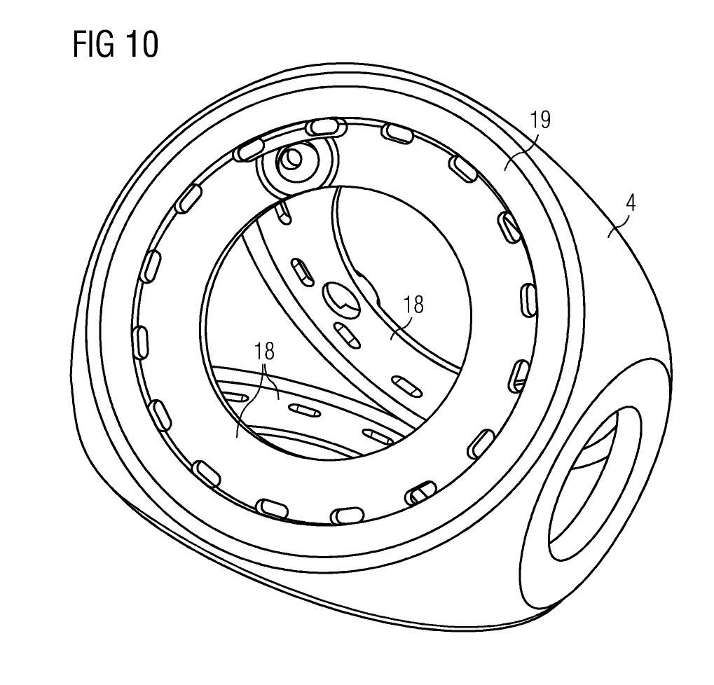

FIG. 10 schematically shows a hub reinforcement plate or a blade root reinforcement plate 18 at the pitch bearings 19 of a wind turbine rotor blade. In this aspect of the invention, the invented component/structure is a hub reinforcement plate or a blade root reinforcement plate 18 at the pitch bearings 19 of a wind turbine rotor blade. The purpose of the reinforcement plate (hub plate as well as blade root blade) 18 is to hinder ovalization of the pitch bearing 19 which in turn may be damaging for the bearing. Furthermore a blade root reinforcement plate normally is the attachment point for the pitch actuators for pitching the blade.

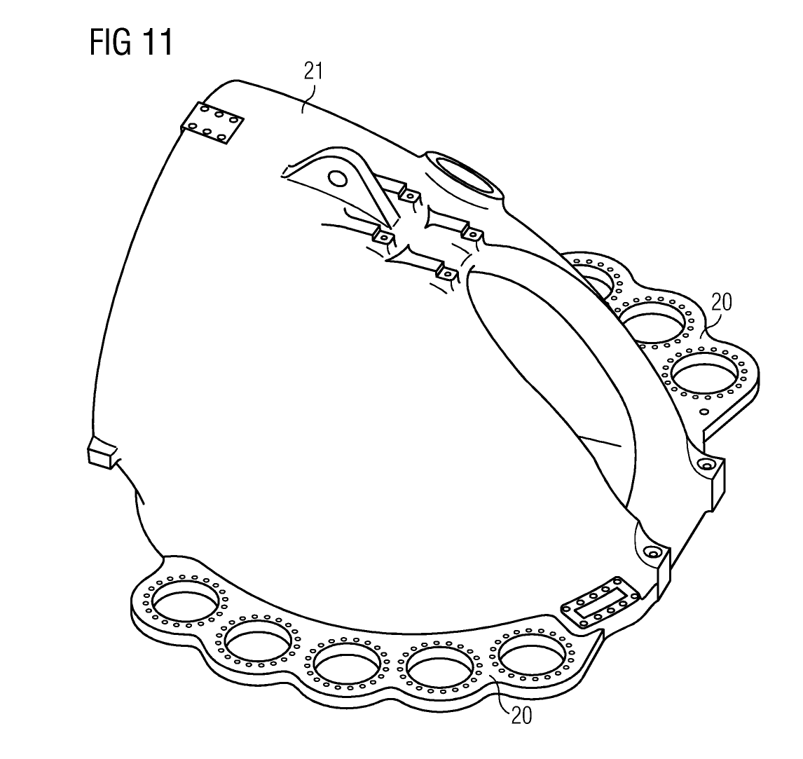

FIG. 11 schematically shows a yaw-frame 20 as being a part of a bed plate 21 of a wind turbine 1, for example a direct drive wind turbine. In this aspect of the invention, the invented component/structure is a yaw-frame 20 of a wind turbine 1. The yaw-frame 20 is here defined as being the part of a wind turbine bed plate 21—or bed frame—which holds the yaw-motors.

The invented composite yaw-frame 20 may be established together with the remaining part of the bed-frame 21 which may be made of similar composite material, or may be made of steel or iron.

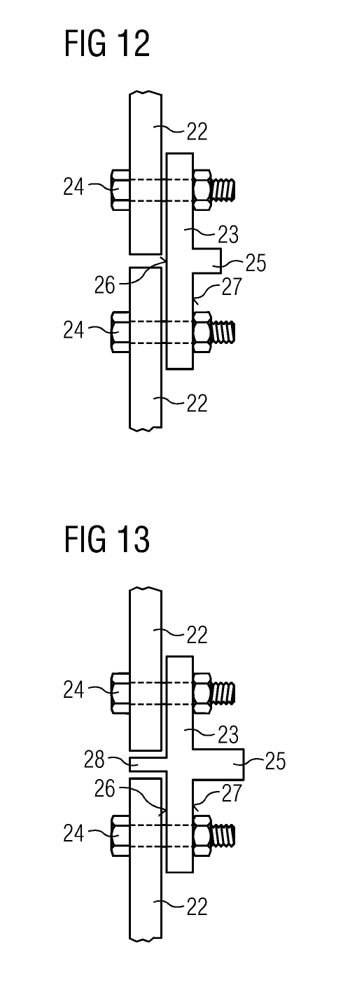

FIGS. 12 to 14 schematically show part of two tower segments 22 connected with flanges 23 in a sectional view. In this aspect of the invention, the invented component/structure is a tower flange 23 of a wind turbine tower 2.

It is known to build wind turbine towers 2 of multiple tower segments 22 each of them comprising tower connection flanges 23 at both their ends. The flanges 23 are used to connect segments 22 tightly together, for instance by means of bolt connections 24. However, the flanges 23 make transport of the wind turbine segments 22 difficult, as the diameter restricts the transportation pathways. One solution is to make flangeless tower segments which can be ovalized during transport hereby allowing transportation of segments with larger basic diameter, but that due to ovalizing has the same clearing height. However, such construction requires separate connectable flanges 23 which according to the present invention may be made of composite material.

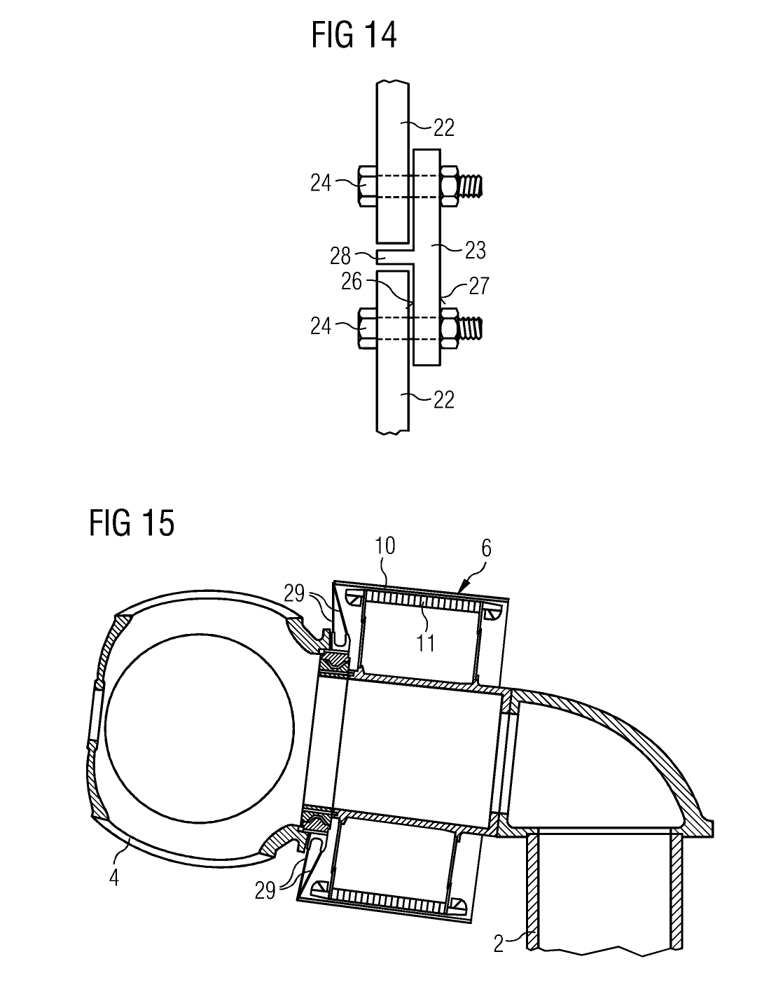

The FIGS. 12, 13 and 14 schematically illustrate three different embodiments of such construction. In FIG. 12 the flange 23 comprises a protrusion 25. The flange 23 comprises an inner surface 26 facing towards the tower segments 22 and an opposite or outer surface 27. The protrusion is located at the outer surface 27. In FIG. 13 the flange 23 comprises a protrusion 25 located at the outer surface 27 as shown in FIG. 12. The flange 23 additionally comprises a protrusion 28 located at the inner surface 26 and between two adjacent tower segments 22. In FIG. 14 the flange 23 comprises a protrusion 28 located at the inner surface 26 and between two adjacent tower segments 22 as shown in FIG. 13.

FIG. 15 schematically shows an embodiment of a direct drive wind turbine in a sectional view. In this aspect of the invention, the invented component/structure is the rotor endplates 29 of a direct drive wind turbine generator 6. As the rotor endplates 29 almost exclusively are influenced by torsion forces during operation, it is relatively simple to construct endplates comprising aligned fibres in the direction of the acting forces.

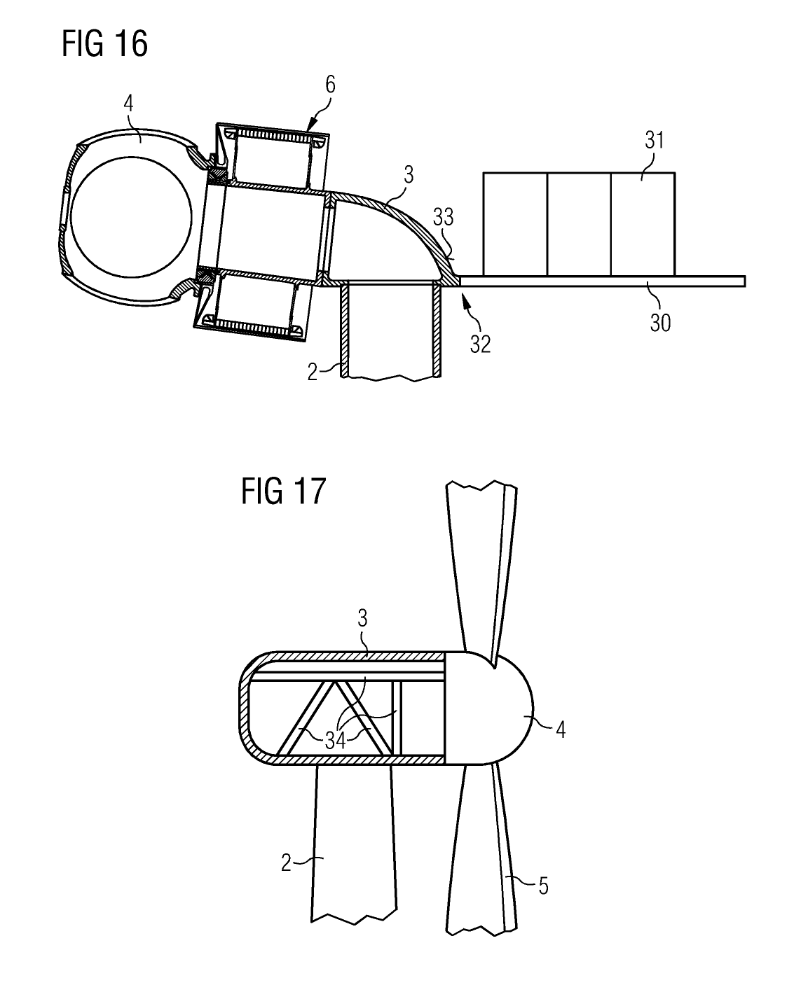

FIG. 16 schematically shows part of a wind turbine with a supporting beam 30 in a sectional view. In this aspect of the invention, the invented component/structure is a supporting beam 30 of a wind turbine 1. E.g. for a direct drive wind turbine construction as schematically illustrated on FIG. 16, electric cabinets 31 etc. may be located in the downwind end 33 of the nacelle 3. This may require one or more beams 30 which are connected to the bedplate at some joint 32. The requirements to the said beams 30 are high as a high bending moment is applied to the construction. Furthermore the construction may cope with the dynamical motion of the wind turbine. Such supporting beams 30 are relatively easy to manufacture as the said bending moments are relatively unidirectional and consequently the orientation of fibres in the structure is non-complex.

1-18. (canceled)

19. A wind turbine, comprising:
a load carrying component,
wherein the load carrying component comprises fibre reinforced composite material.

20. The wind turbine as claimed in claim 1, further comprising:
a stator endplate or rotor endplate of a direct drive generator,
wherein the stator endplate or rotor endplate comprises fibre reinforced composite material.

21. The wind turbine as claimed in claim 1, further comprising a stator hollow tube construction of a direct drive generator,
wherein the stator hollow tube construction comprises fibre reinforced composite material.

22. The wind turbine as claimed in claim 1, further comprising a rotor sleeve of a direct drive generator,
wherein the rotor sleeve comprises fibre reinforced composite material.

23. The wind turbine as claimed in claim 1, further comprising a shaft of a direct drive generator connecting a hub to a generator,
wherein the shaft comprises fibre reinforced composite material.

24. The wind turbine as claimed in claim 1, further comprising a shaft connecting the hub to the gearbox of a geared turbine or connecting the hub to the hydraulic aggregate of a hydraulic geared turbine,
wherein the shaft comprises fibre reinforced composite material.

25. The wind turbine as claimed in claim 1, further comprising a hub of a direct drive generator, a geared or a hydraulic geared turbine,
wherein the hub comprises fibre reinforced composite material.

26. The wind turbine as claimed in claim 1, further comprising a reinforcement plate at the blade root of a direct drive generator, a geared or a hydraulic geared turbine,
wherein the reinforcement plate comprises fibre reinforced composite material.

27. The wind turbine as claimed in claim 1, further comprising a yaw-frame of a direct drive generator, a geared or a hydraulically geared turbine,
wherein the yaw-frame comprises fibre reinforced composite material.

28. The wind turbine as claimed in claim 1, further comprising a tower flange, wherein the tower flange comprises fibre reinforced composite material.

29. The wind turbine as claimed in claim 1, further comprising a supporting beam,
wherein the supporting beam comprises fibre reinforced composite material.

30. The wind turbine as claimed in claim 1, further comprising a canopy supporting structure,
wherein the canopy supporting structure comprises fibre reinforced composite material.

31. The wind turbine according to claim 1,
wherein the fibers of a part of the reinforced material is configured as continuous aligned fibre reinforced material and the fibers of the part of the reinforced material is configured as discontinuous aligned fibre reinforced material and the fibers of the part of the reinforced material is configured as discontinuous random oriented fibre reinforced material.

32. The wind turbine according to claim 1,
wherein the fibers of a part of the reinforced material is configured as continuous aligned fibre reinforced material or the fibers of the part of the reinforced material is configured as discontinuous aligned fibre reinforced material or the fibers of the part of the reinforced material is configured as discontinuous random oriented fibre reinforced material.

33. The wind turbine according to claim 1,
wherein the reinforcement fibers are embedded in the composite material.

34. The wind turbine according to claim 1,
wherein the reinforcement comprises reinforcement bars.

35. The wind turbine according to claim 1, wherein the material of the fibers are selected from the group consisting of steel, carbon, glass, Kevlar, basalt and any combination thereof

36. The wind turbine according to claim 1, wherein the composite material comprises a resin matrix.

37. The wind turbine according to claim 1, wherein the material of the matrix are selected from the group consisting of concrete, epoxy, polyester, vinylester, iron, steel and any combination thereof.
